(19) United States
(12) Patent Application Publication
(10) Pub. No.: US 2013/0261044 A1
(43) Pub. Date: Oct. 3, 2013

(54) Cleaning Composition for Hard Surface

(71) Applicants: Florence Lambert, Paris (FR); Celine Orizet, Bourg-La-Reine (FR); Sebastien Serrurier, Frepillon (FR)

(72) Inventors: Florence Lambert, Paris (FR); Celine Orizet, Bourg-La-Reine (FR); Sebastien Serrurier, Frepillon (FR)

(73) Assignee: RHODIA OPERATIONS, Aubervilliers (FR)

(21) Appl. No.: 13/823,026

(22) PCT Filed: Sep. 30, 2011
(86) PCT No.: PCT/EP2011/067074

§ 371 Date: Jun. 18, 2013

Related U.S. Application Data
(60) Provisional application No. 61/344,771, filed on Oct. 1, 2010.

(51) Int. Cl. C11D 3/00; C11D 3/30

(52) U.S. Cl. CPC C11D 3/0036; C11D 3/30
USPC 510/400; 536/52

(57) ABSTRACT

The present invention relates to the use of at least one cationic polysaccharide to hydrophilize a hard surface and/or to provide anti-deposition, anti-adhesion and anti-soil properties to said surface. The invention also relates to a hard cleaning composition comprising such cationic polysaccharide and a method for hydrophilizing a hard surface having a hydrophobic surface, comprising treating at least a portion of such hydrophobic surface with the cationic polysaccharide as such.

The present invention relates to hard surface cleaning composition containing a cationic polysaccharide and a method for cleaning hard surfaces, such as ceramic, tiling, metal, melamine, formica, plastic, glass, mirror, and other industrial, kitchen and bathroom surfaces.

Detergent or cleaning compositions make it possible to clean industrial and domestic hard surfaces. Cleaning compositions generally contain surfactants; solvents, for example alcohol, to possibly facilitate drying; sequestering agents; and bases or acids to adjust the pH. The surfactants are generally non-ionic and anionic combinations, or non-ionic and cationic combinations. A frequent disadvantage of these cleaning compositions is that the subsequent contact of the hard surface with water leads to the formation of hard water deposits when the surface dries. Moreover, conventional cleaning compositions merely clean the surface, but do little to prevent future soiling.

One object of the invention is to provide a cleaning composition for hard surfaces which imparts improved anti-deposition and/or anti-adhesion properties to a hard surface, particularly anti-soil deposition, re-deposition and/or anti-soil adhesion properties. Another object of the invention is to provide more durable hydrophilizing low surface energy hard substrates.

The present invention provides the use of cationic polysaccharide in hard surface cleaning composition.

For purposes of this specification a composition for cleaning includes compositions for cleaning and compositions for rinsing.

The invention relates to a hard surface cleaning composition comprising at least one cationic polysaccharide.

Advantageously the cationic polysaccharide has an average molecular weight between 20,000 and 5,000,000 g/mol, preferably between 20,000 and 4,000,000 g/mol; preferably between 100,000 and 3,000,000 g/mol.

As used herein, the “average molecular weight” of the cationic polysaccharide means the weight average molecular mass of said cationic polysaccharide.

The average molecular weight of the cationic polysaccharide may be measured by SEC-MALS (Size Exclusion Chromatography with detection by Multi-Angle Light-Scattering detection). A value of 0.140 for dn/dc is used for the molecular weight measurements. A Wyatt MALS detector is calibrated using a 22.5 KDa polyethylene glycol standard. All calculations of the molecular weight distributions are performed using Wyatt's ASTRA software. The samples are prepared as 0.05% solutions in the mobile phase (100 mM Na₂NO₃, 200 ppm NaN₃, 20 ppm pDADMAC) and filtered through 0.45 μm PVDF filters before analysis. The average molecular weights are expressed by weight.

According to the present invention the expression “between x and y” should be understood as including the values x and y. According to the invention, this expression also means “from x to y”.

In one embodiment, the cationic group of the cationic polysaccharide is non-polymer cationic group.

The cationic polysaccharide according to the invention can be chosen among the backbone polysaccharidic polymer comprising cationic substituent such as those described in U.S. Pat. No. 3,589,578 and U.S. Pat. No. 4,031,307. The terms “cationic substituent” or “cationic group” refer to positively charged substituent or group and to partially charged substituent or group. As used therein, the expression “partially charged substituent or group” designates substituent or group which may become positively charged depending of the pH of the formulation, the expression “potentially cationic” should also be used.

Those cationic polysaccharides are polymers obtained by chemically modifying polysaccharides, especially natural polysaccharides, such as cellulose, starch or guar, preferably guar. This chemical modification, also called “derivatisation” enable to introduce lateral groups on the polysaccharide backbone, generally linked via ether bounds wherein the oxygen atom corresponds to hydroxyl groups of the polysaccharide backbone which have reacted. Preferably, the cationic groups of the cationic polysaccharides according to the invention are or comprise quaternary ammonium groups.

Advantageously, the cationic polysaccharide of the invention is chosen among cationic cellulose, cationic starch or cationic guar, preferably cationic guar.

In one embodiment the cationic polysaccharide is cationic cellulose, in particular cellulose ether such as those described in U.S. Pat. No. 6,833,347.

Cationic cellulose that could be used in the invention are cellulose modified by quaternary ammonium cationic group, typically quaternary ammonium group carrying three radicals which are identical or different and chosen in the group consisting of hydrogen, alkyl radical from 1 to 10 carbon atoms, preferably from 1 to 6 carbon atoms, advantageously from 1 to 3 carbon atoms, aryl, those three radical being preferably identical or different and represent alkyl radical. Typically, the quaternary ammonium groups are trialkylammonium groups, such as trimethylammonium, triethylammonium, tributylammonium, aryldialkylammonium, especially benzyldimethylammonium, and/or ammonium radicals in which the nitrogen atom is a member of a cyclic structure, such as pyridinium and imidazoline, each in combination with a counter ion, especially chloride. The counter ion of the quaternary ammonium group is generally a halogen, such as a chloride ion, or alternately a bromide or iodide.

Preferred cationic cellulose includes cationic cellulose chosen in the group consisting of cellulose triméthyalmmonium-3 propyl poly(oxyethanediyl-1,2) hydroxyl-2 chloride or polyquaternium-10 (PQ10). It could also includes the Ucar® product sold by Dow, especially Ucar® JR30M, Ucar® JR 400, Ucare® JR 125, Ucare® LR400 and Ucare® LK400.

Cationic guar that could be used in the invention are advantageously guar or guar derivatives, such as hydroxyalkyl guars (hydroxyethyl guars or hydroxypropyl guars), that have been modified with one or more cationizing agents containing reactive groups.

The cationic guar are obtained by reaction between the hydroxyl groups of the guar or of the guar derivatives and the reactive functional groups of the cationizing agents. Methods for the preparation of the cationic guar are disclosed in U.S. Pat. Nos. 4,663,159; 5,473,059; 5,387,675; 3,472,840; 4,031,307; 4,959,464 and US 2010/0029929, all of which are incorporated herein by reference.

Cationizing agents of the present invention are defined as compounds which, by reaction with the hydroxyl groups of the guar can lead to a cationic guar comprising at least one cationic group according to the invention. Cationizing agents of the present invention are defined as compounds which contain at least one cationic moiety. Cationizing agents comprise agents which can lead to cationic guar. A group of suitable cationizing reagents typically contain a reactive functional group, such as an epoxy group, a halide group, an ester group, an anhydride group or an ethylenically unsaturated group, and at least one cationic moiety or a precursor of such cationic moiety.

Preferably, the cationic group or substituent comprises at least one cationic charge.

Cationic guar that could be used in the invention are preferably and advantageously guar or guar derivatives, such as hydroxyalkyl guars (hydroxyethyl guars or hydroxypropyl guars), preferably guar, modified by quaternary ammonium cationic group, typically quaternary ammonium group carrying three radicals which are identical or different and chosen in the group consisting of hydrogen, alkyl radical from 1 to 22 carbon atoms, preferably from 1 to 14 carbon atoms, advantageously from 1 to 3 carbon atoms, or aryl radical, those three radicals being preferably identical or different and represent alkyl radical or aryl radical. Typically, the quaternary ammonium groups are trialkylammonium groups, such as trimethylammonium, triethylammonium, tributylammonium, aryldialkylammonium, especially benzyldimethylammonium, and/or ammonium radicals in which the nitrogen atom is a member of a cyclic structure, such as pyridinium and imidazoline, each in combination with a counter ion, especially chloride, bromide or iodide.

Cationic guars well adapted to the invention are modified guar obtained for example with the “derivatisation” technique described in WO2009/099567 and WO2010/014219.

In one embodiment, the cationic group of the cationic guar is linked to the reactive functional group of the cationisation agent, for example via an alkylene or oxyalkylene linking group.

Suitable cationisation group are for example chosen in the group consisting of cationic nitrogen compound functionalized with epoxy, such as for example, 2,3-epoxypropyltrimethylammonium chloride, 2,3-epoxypropyltrimethylammonium bromide or 2,3-epoxypropyltrimethylammonium iodide, cationic nitrogen compound functionalized with chloride such as for example 3-halogeno-2-hydroxypropyl trimethylammonium chloride, for example 3-chloro-2-hydroxypropyl trimethylammonium chloride, 3-chloro-2-hydroxypropyllauryldimethylammonium chloride, 3-chloro-2-hydroxypropylstearyldimethylammonium chloride, and cationic nitrogen compounds functionalized with vinyl or (meth)acrylamide functions, such as methacrylamidopropyl trimethylammonium chloride, trimethylammoniumpropyl methacrylamide methylsulfate salt, diallyl dimethyl ammonium chloride, vinyl benzyl trimethylammonium chloride, precursor of cationic monomers such as N-vinyl formamide, N-vinylacetamide (whose units can be hydrolyzed after polymerization or grafted onto vinyl amine units).

The reactive agent could also be non cationic precursors of the reactive mentioned above, e.g. the cationic guar can be obtained by grafting with chloroalkyl dialkylamine (e.g. diethylaminoethylchloride, dimethylaminopropylmethacrylamide . . . ) followed by a step of quaternarization, such step is known from the person skilled in the art and can be, for example, carried out with dimethylsulfate, diethylsulfate and methyl chloride.

The cationic group used to modify guar can also be for example hydroxypropyl ammonium. Those compounds can be obtained for example by reacting a guar gum with compounds such as 2,3-epoxypropyltrimethylammonium chloride or 3-chloro-2-hydroxypropyl-trimethylammonium chloride.

Examples of particular cationic guar that can be used in the invention are Jaguar C17 and Jaguar C14S, Jaguar C13S.

Examples of particular cationic cellulose that can be used in the invention are Polycare 400 (polyquaternium-10) commercialized by Rhodia and Ucare JR400 polyquaternium-10 commercialized by DOW Amerchol.

The cationic substituent on the cationic starch is the same that those described above for the cationic cellulose and the cationic guar.

Typically, the cationicity of the non-cellulosic polysaccharide derivative can be expressed in terms of degree of substitution.

The cationic degree of substitution may be determined before or after an acidic methanol extraction. The acidic methanol extraction may be considered as a washing step, allowing the removal of the other quaternary ammonium compounds present at the end of the reaction, being it residual cationizing reagent or by-products of unreacted cationizing agent. In general, the cationic degree of substitution after acidic methanol extraction (DS_{cat})_{extraction} is lower than the cationic degree of substitution before said extraction (DS_{cat}).

In the present invention, the cationic degree of substitution determined after the acidic methanol extraction (DS_{cat})_{extraction} is more precise.

As used herein, the (DS_{cat}) or (DS_{cationic}) relates to the cationic degree of substitution measured before the acidic methanol extraction.

As used herein, the (DS_{cat})_{extraction} or (DS_{cat})_{extc} relates to the cationic degree of substitution measured after the acidic methanol extraction.

As used herein, the expression “cationic degree of substitution” (DS_{cat}) or (DS_{cat})_{extraction} means the average number of moles of cationic groups per mole of sugar unit. The (DS_{cat}) or (DS_{cat})_{extraction} may be measured by means of ¹H-NMR (solvent: D₂O).

Once the 1H NMR spectrum is obtained, the integration of the multiplet of peaks corresponding to the anomeric proton on all guar units, usually between 3.2-4.3 ppm, is normalized to unity. The peak of interest, the one corresponding to the methyl protons of the quaternary ammonium group on guar units, is centered around 1.8 ppm. This peak is integrated for 9 protons given that there are 3 methyl groups on the ammonium function. Therefore the calculation of the (DS_{cationic}) for the case of the cationizing agent 2,3-epoxypropyltrimethylammonium chloride is as follows:

$$DS = \frac{INTEGRAL\_N ( Me ) 3}{INTEGRAL\_anomeric \_proton} / 9$$

The measurement of the degree of cationic substitution was made before (DS_{cationic}) and after a cleaning protocole (DS_{cat})_{extraction}. The true value of degree of cationic substitution is thus considered to be that measured after removal of cationic impurities. Indeed, the presence of the residuals/by-products of the cationic reagent is evidenced by the smaller peaks at lower field than the peak of interest centered around 1.8 ppm and in fact leads to an increase of the apparent value of (DS_{cationic}).

According to the present invention, a process of extraction of the cationic polysaccharide may be carried out in acidified methanol (50:1, MeOH/HCl_{concentrated 37%}, v/v) for removing all of cationic reagent impurities. Thus, the cationic polysaccharide is added to an acidified methanol mixture in a concentration equivalent to approximately 1%, under stirring. This dispersion is then brought to reflux temperatures and held at temperature for 45 minutes. At the end of this process of extraction, the solvent is decanted and the process is repeated twice more with fresh acidified solvent. After the last extraction the resulting cationic polysaccharide is filtered and washed with pure methanol. The so purified cationic polysaccharide is then dried and ground before NMR analysis.

Advantageously, the degree of cationic substitution after extraction (DScat)_{extraction} of the cationic polysaccharide is comprised between about 0.05 and 0.5, preferably between about 0.05 and 0.3, preferably between about 0.05 and 0.2. The degree of cationic substitution expresses the average number of moles of cationic substitution per mole of sugar unit. Advantageously, the weight ratio of the polysaccharide according to the total weight of the cleaning composition is comprised between 0.01% and 1%, preferably between 0.01% and 0.5%, based on actives.

The composition of the invention advantageously confers one or more of the following properties to the surface on which it is deposited:
hydrophilization of all or part of the surface;
anti-deposition properties;
anti-adhesion properties;
anti-soil properties, especially anti-soil deposition, adhesion and redeposition properties.

Advantageously, the composition of the invention makes it possible to confer, on the surface treated, persistent anti-deposition and/or anti-adhesion properties with regard to soiling substances.

The composition of the invention can be provided in any form and can be used in multiple ways.

It can be in the form of a gelled or ungelled liquid to be deposit as such, in particular by spraying. It can be in the form of a gelled or ungelled liquid to be diluted in water before being applied to the surface to be treated, a gelled or ungelled liquid held in a water-soluble bag, a foam, an aerosol, a liquid adsorbed on an adsorbent substrate made of an article which is chosen or nonwoven in particular (wipe), a solid in particular a tablet, optionally held in a water-soluble bag, it being possible for the composition to represent all or part of the tablet.

Advantageously, the composition according to the invention is under the liquid form, spray form, gel form, wipes form.

The cleaning or rinsing composition according to the invention may additionally comprise one or more of the following compounds: surface-active agent (especially nonionic, anionic, amphoteric, zwitterionic or cationic), polymers, especially polymers used to control the viscosity of the mixture and/or the stability of the foams formed during the use of the composition, hydrotropic agents, biocides or disinfectants (especially cationic biocides or disinfectants), solvent (especially having a good cleaning or degreasing activity and water soluble solvent), cosolvent, pH modifiers. Any other compounds usually used in cleaning compositing and known by the person skilled in the art can be added in the composition of the invention.

### Anionic Surface-Active Agents

Typical anionic surface-active agents for use in the present invention, by way of example, are:
alkyl ester sulfonates of formula R—CH(SO₃M)-COOR′, where R represents a C₈-C₂₀, preferably C₁₀-C₁₆, alkyl radical, R′ represents a C₁-C₆, preferably C₁-C₃, alkyl radical and M represents an alkali metal (sodium, potassium or lithium) cation, a substituted or unsubstituted ammonium (methyl-, dimethyl-, trimethyl- or tetramethylammonium, dimethylpiperidinium, and the like) cation or a cation derived from an alkanolamine (monoethanolamine, diethanolamine, triethanolamine, and the like). Mention may very particularly be made of methyl ester sulfonates in which the R radical is C₁₄-C₁₆ radical;
alkyl sulfates of formula ROSO₃M, where R represents a C₅-C₂₄, preferably C₁₀-C₁₈, alkyl or hydroxyalkyl radical (such as salts of fatty acids derived from copra and tallow), M representing a hydrogen atom or a cation with the same definition as above, and their ethoxylenated (EO) and/or propoxylenated (PO) derivatives, having on average from 0.5 to 30, preferably from 0.5 to 10, EO and/or PO units;
alkylamide sulfates of formula RCONHR′OSO₃M, where R represents a C₂-C₂₂, preferably C₆-C₂₀, alkyl radical and R′ represents a C₂-C₃ alkyl radical, M representing a hydrogen atom or a cation with the same definition as above, and their ethoxylenated (EO) and/or propoxylenated (PO) derivatives, having on average from 0.5 to 60 EO and/or PO units;
salts of saturated or unsaturated C₅-C₂₄, preferably C₁₄-C₂₀, fatty acids, C₃-C₂₀ alkylbenzenesulfonates, primary or secondary C₅-C₂₂ alkylsulfonates, alkylglycerolsulfonates, the sulfonated poly-carboxylic acids disclosed in GB-A-1 082 179, paraffin sulfonates, N-acyl-N-alkyltaurates, isethionates, alkylsuccinamates, alkylsulfo-succinates, monoesters or diesters of sulfosuccinates, N-acylsarcosinates, alkylglycoside sulfates, polyethoxycarboxylates, monoglyceride sulfates and condensates of fatty acid chlorides with hydroxyalkylsulfonates; the cation can be an alkali metal (sodium, potassium or lithium), a substituted or unsubstituted ammonium (methyl-, dimethyl-, trimethyl- or tetramethylammonium, dimethylpiperidinium, and the like) residue, or a residue derived from an alkanolamine (monoethanolamine, diethanolamine, triethanolamine, and the like);
alkyl phosphates, or alkyl or alkylaryl phosphate esters, such as Rhodafac RA600, Rhodafac PA15 or Rhodafac PA23, sold by Rhodia; the cation can be an alkali metal (sodium, potassium or lithium), a substituted or unsubstituted ammonium (methyl-, dimethyl-, trimethyl- or tetramethylammonium, dimethylpiperidinium, and the like) residue, or a residue derived from an alkanolamine (monoethanolamine, diethanolamine, triethanolamine, and the like).

### Nonionic Surface-Active Agents

A description of nonionic surface-active agents is given in U.S. Pat. No. 4,287,080 and U.S. Pat. No. 4,470,923. Mention may in particular be made of condensates of alkylene oxide, in particular of ethylene oxide and optionally of propylene oxide, with alcohols, polyols, alkylphenols, fatty acid esters, fatty acid amides and fatty amines; amine oxides; sugar derivatives, such as alkylpolyglycosides or esters of fatty acids and of sugars, in particular sucrose monopalmitate; long-chain (of 8 to 28 carbon atoms) tertiary phosphine oxides; dialkyl sulfoxides; block copolymers of polyoxyethylene and of polyoxypropylene; polyalkoxylated esters of sorbitan; fatty esters of sorbitan; poly(ethylene oxide)s and fatty acid amides modified so as to confer thereon a hydrophobic nature (for example, fatty acid mono- and diethanolamides comprising from 10 to 18 carbon atoms).

Typical nonionic surface-active agents for use in the present invention, by way of example, are:
polyoxyalkylenated C₈-C₁₈ aliphatic carboxylic acids comprising from 2 to 50 oxyalkylene (oxyethylene and/or oxypropylene) units, in particular of those with 12 (mean) carbon atoms or with 18 (mean) carbon atoms,
polyoxyalkylenated C₆-C₂₄ aliphatic alcohols comprising from 2 to 50 oxyalkylene (oxyethylene and/or oxypropylene) units, in particular of those with 12 (mean) carbon atoms or with 18 (mean) carbon atoms; mention may be made of Antarox B12DF, Antarox FM33, Antarox FM63 and Antarox V74 from Rhodia, Plurafac LF 400 and Plurafac LF 220 from BASF, Rhodasurf ID 060, Rhodasurf ID 070 and Rhodasurf LA 42 from Rhodia and Synperonic A5, A7 and A9 from ICI,
amine oxides, such as dodecyldi(2-hydroxyethyl)amine oxide,
phosphine oxides, such as tetradecyldimethylphosphine oxide.

### Amphoteric Surface-Active Agents

Typical amphoteric surface-active agents for use in the present invention, by way of example, are:
sodium iminodipropionates or alkyliminopropionates, such as MIRATAINE H2C HA and MIRATAINE JC HA from Rhodia,
alkyl amphoacetates or alkyl amphodiacetates, the alkyl group of which comprises from 6 to 20 carbon atoms, such as MIRANOL C2M Conc NP, sold by Rhodia,
amphoteric alkylpolyamine derivatives, such as Amphionic XL®, sold by Rhodia, and Ampholac 7T/X® and Ampholac 7C/X®, sold by Berol Nobel.

### Zwitterionic Surface-Active Agents

Typical zwitterionic surface-active agents for use in the present invention, by way of example, are disclosed in U.S. Pat. No. 5,108,660.

A number of suitable zwitterionic surfactants are alkyl dimethyl betaines, alkyl amidopropyldimethyl betaines, alkyl dimethyl sulfobetaines or alkyl amidopropyldimethyl sulfobetaines, such as MIRATAINE JCHA, MIRATAINE H2CHA or MIRATAINE CBS, sold by Rhodia, or those of the same type sold by Sherex Company under the name of “Varion CADG Betaine” and “Varion CAS Sulfobetaine”, or the condensation products of fatty acids and of protein hydrolysates.

Other zwitterionic surfactants are also disclosed in U.S. Pat. No. 4,287,080 and in U.S. Pat. No. 4,557,853.

Another zwitterionic is a betaine, for example, those disclosed by US Patent Application Publication No. 2006/0217286 incorporated herein by reference in its entirety.

Examples of polymers used to control the viscosity of the mixture and/or the stability of the foams formed during use, are cellulose derivatives or guar derivatives (carboxymethylcellulose, hydroxyethylcellulose, hydroxypropylguar, carboxymethylguar, carboxymethylhydroxypropylguar, and the like), xanthan gum, succinoglycan (Rheozan® sold by Rhodia), locust bean gum or carrageenans (in a proportion of 0 to 2% of the total weight of said cleaning composition).

Example of hydrotropic agents, are short-chain C₂-C₈ alcohols, in particular ethanol, diols and glycols, such as diethylene glycol or dipropylene glycol, sodium xylenesulfonate or sodium naphthalenesulfonate (in a proportion of 0 to 10 g per 100 g of said cleaning composition).

### Examples of Biocides or Disinfectants are:

cationic biocides, for example mono(quaternary ammonium) salts, such as cocoalkylbenzyldimethylammonium, (C₁₂-C₁₄ alkyl)-benzyldimethylammonium, cocoalkyldichlorobenzyl-dimethylammonium, tetradecylbenzyldimethylammonium, didecyldimethylammonium or dioctyldimethylammonium chlorides; myristyltrimethylammonium or cetyltrimethylammonium bromides,
monoquaternary heterocyclic amine salts, such as laurylpyridinium, cetylpyridinium or (C₁₂-C₁₄ alkyl)benzylimidazolium chlorides,
(fatty alkyl)triphenylphosphonium salts, such as myristyltriphenylphosphonium bromide,
polymeric biocides, such as those derived from the reaction
   of epichlorohydrin and of dimethylamine or of diethylamine,
   of epichlorohydrin and of imidazole,
   of 1,3-dichloro-2-propanol and of dimethylamine,
   of 1,3-dichloro-2-propanol and of 1,3-bis(dimethylamino)-2-propanol,
   of ethylene dichloride and of 1,3-bis(dimethylamino)-2-propanol,
   of bis(2-chloroethyl)ether and of N,N′-bis(dimethyl-aminopropyl)urea or -thiourea,
biguanidine polymer hydrochlorides, such as VANTOCIL IB,
amphoteric biocides, such as N—[N′—(C₈-C₁₈ alkyl)-3-aminopropyl]glycine, N—{N′—[N″—(C₈-C₁₈ alkyl)-2-aminoethyl]-2-aminoethyl}glycine or N,N-bis[N′—(C₈-C₁₈ alkyl)-2-aminoethyl]glycine derivatives, such as (dodecyl)(aminopropyl)glycine or (dodecyl)(diethylenediamine)glycine,
amines, such as N-(3-aminopropyl)-N-dodecyl-1,3-propanediamine,
halogenated biocides, such as iodophores and hypochlorite salts, such as sodium dichloroisocyanurate,
phenolic biocides, such as phenol, resorcinol, cresols or salicylic acid,
hydrophobic biocides, such as
   para-chloro-meta-xylenol or dichloro-meta-xylenol,
   4-chloro-m-cresol,
   resorcinol monoacetate,
   mono- or polyalkyl or -aryl phenols, cresols or resorcinols, such as o-phenylphenol, p-tert-butylphenol, or 6-(n-amyl)-n-cresol,
   alkyl and/or aryl chloro- or bromophenols, such as o-benzyl-p-chlorophenol,
   halogenated diphenyl ethers, such as 2′,4,4′-trichloro-2-hydroxydiphenyl ether (triclosan) or 2,2′-dihydroxy-5,5′-dibromodiphenyl ether,
   chlorphenesin (p-chlorophenyl glyceryl ether), in a proportion of 0 to 50% of the total weight of said cleaning composition.

Examples solvents having a good cleaning or degreasing activity are
alkylbenzenes of octylbenzene type,
olefins having a boiling point of at least 100° C., such as α-olefins, preferably 1-decene or 1-dodecene,
glycol ethers of general formula R1O(R2O)ₘH, where R1 is an alkyl group exhibiting from 3 to 8 carbons and each R2 is either an ethylene or propylene and m is a number which varies from 1 to 3; mention may be made of monopropylene glycol monopropyl ether, dipropylene glycol monobutyl ether, monopropylene glycol monobutyl ether, diethylene glycol monohexyl ether, monoethylene glycol monohexyl ether, monoethylene glycol monobutyl ether and their mixtures,
diols exhibiting from 6 to 16 carbon atoms in their molecular structure; diols are particularly advantageous as, in addition to their degreasing properties, they can help in removing calcium salts (soaps); diols comprising from 8 to 12 carbon atoms are preferred, very particularly 2,2,4-trimethyl-1,3-pentanediol,
other solvents, such as pine oil, orange terpenes, benzyl alcohol, n-hexanol, phthalic esters of alcohols having 1 to 4 carbon atoms, butoxy propanol, Butyl Carbitol and 1-(2-(n-butoxy)-1-methylethoxy)propan-2-ol, also known as butoxypropoxy propanol or dipropylene glycol monobutyl ether, diglycol hexyl (Hexyl Carbitol), butyl triglycol, diols, such as 2,2,4-trimethyl-1,3-pentanediol, and their mixtures, (in a proportion of 0 to 30% of the total weight of said cleaning composition).

Examples of water-soluble organic solvents with little cleaning effect are methanol, ethanol, isopropanol, ethylene glycol, propylene glycol and their mixtures (in a proportion of 0 to 40% of the total weight of said cleaning composition).

Examples of cosolvents, are monoethanolamide and/or β-aminoalkanols, which are particularly advantageous in compositions with a pH of greater than 11, very particularly of greater than 11.7, as they help in reducing the formation of films and marks on hard surfaces (they can be employed in a proportion of 0.05 to 5% of the weight of the cleaning composition); solvent systems comprising monoethanolamide and/or β-aminoalkanols are disclosed in U.S. Pat. No. 5,108,660.

The pH of the composition or the pH of use of the composition depends on the surface to treat, it can for example be comprised between 1 and 14, preferably between 2 and 11.

As used herein in reference to a hydrophobic surface, the term hydrophilizing means rendering such surface more hydrophilic and thus less hydrophobic, as indicated by a decreased water contact angle.

As used herein in reference to a substrate, the terminology “water contact angle” means the contact angle exhibited by a droplet of water on the surface as measured by a conventional image analysis method, that is by disposing a droplet of water on the surface, typically a substantially flat surface, at 25° C., photographing the droplet, and measuring the contact angle shown in the photographic image.

The term “persistent anti-deposition and/or anti-adhesion properties” is understood to mean that the treated surface retains these properties over time, including after subsequent contacts with a soiling substance. This property of persistence can be observed beyond approximately 10 rinsing cycles, indeed even, in some specific cases beyond 100 rinsing cycles.

The expression of <<conferring, on the surface thus treated, anti-deposition properties>> means more particularly that the treated surface, brought into contact with a soiling substance in predominantly aqueous medium, will not have a tendency to <<capture>> said soiling substance on the surface.

The expression “conferring on the surface thus treated anti-adhesion properties” means more particularly that the treated surface is capable of interacting only very slightly with the soiling substance which has been deposited thereon, which makes possible easy removal of the soiling substances from the soiled treated surface; this is because during the drying of the soiling substance brought into contact with the treated surface, the bonds developed between the soiling substance and the surface are very weak; thus, to break these bonds requires less energy (as a consequence less effort) during the cleaning operation.

The property of hydrophilization of the surface makes it possible in addition to reduce the formation of condensation on the surface; this advantage can be made use of in cleaning formulations for windows and mirrors, in particular in bathroom. Furthermore, the rate of drying of the surface, immediately after treatment thereof by the application of the composition according to the invention but also after subsequent and repeated contacts with an aqueous medium, is very significantly improved.

The term “hard surfaces” refers to non-textile surfaces and can equally be domestic, communal or industrial surfaces.

They can be made of any material, in particular of the following types: ceramic, glass, metal, synthetic resins, melamine, formica, plastics (for example poly(vinyl chloride), polyamide)

The invention also relates to a cleaning composition according to the invention for treating or pre-treating a hard surface of an article. Consistent with this the present invention is directed to a treated or pre-treated article, comprising:
(a) a hard surface substrate having a hydrophobic surface and
(b) a hydrophilising layer disposed on at least a portion of the hydrophobic surface of the substrate the layer comprising cationic polysaccharide according to the invention.

The treatment of surfaces with the composition of the invention results in changed surface properties, especially the surface is hydrophilized and has anti-soil property.

The invention also relates to the use of at least one cationic polysaccharide to hydrophilize a hard surface and/or to provide anti-deposition, anti-adhesion and anti-soil properties to this surface. The cationic polysaccharide being as defines above.

In one embodiment the cationic polysaccharide is comprised in a hard surface cleaning composition. The hard surface cleaning composition being as defines above.

The invention also relates to a composition comprising at least one cationic polysaccharide suitable to hydrophilize a hard surface and/or to provide anti-deposition, anti-adhesion and anti-soil properties to this surface. The cationic polysaccharide and the composition being as define above.

The invention also relates to a method for hydrophilizing a hard surface having a hydrophobic surface, comprising treating at least a portion of such hydrophobic surface with the composition according to the invention to deposit a hydrophilizing layer on such portion of such hydrophobic surface.

The invention also relates to a method for providing anti-deposition, anti-adhesion and anti-soil properties to a surface comprising treating at least a portion of such surface with the composition according to the invention.

The invention also relates to a method for cleaning and/or rinsing a hard surface with the composition of the invention.

The invention will now be described with non limitative examples.

### EXAMPLE 1

### Anti-Soil Benefit of Cationic Guar in HSC Composition

### General Protocol

a. Melamine Surface Preparation:

The tile is cleaned with ethanol and then wiped.

b. Surface Treatment:

10 drops of detergent formulation are applied with a pipette for one part of the tile and the surface is then wiped with a kimwipe.

The surface is then dried for about 1 min.

### Detergent Formulations Tested: Kitchen Cleaner

Reference Solution (No polymer): Mirataine JC HA 0.9%, Rhodoclean EFC 1%, Isopropanol 3%, Dowanol PnB, water. pH 8.5
Solution 1: Reference solution +1% MIRAPOL Surf-S210 (2.2% active), water pH 8.5
Solution 2:: Reference solution +1% of a solution at 2.2% guar (non cationic) Jaguar S, water pH 8.5
Solution 3: Reference solution +1% of a solution at 2.2% of a cationic guar sold by Rhodia under the trade name Jaguar C500®, water pH 8.5
Solution 4:: Reference solution +1% of a solution at 2.2% of a cationic guar sold by Rhodia under the trade name Jaguar C135®, water pH 8.5
Solution 5:: Reference solution +1% of a solution at 2.2% of a cationic guar sold by Rhodia under the trade name Jaguar C17®, water pH 8.5

The guars used in solutions 3, 4 and 5 exhibit a (DS_{cat})_{extraction} in accordance with the invention (and more especially a (DS_{cat})_{extraction} comprised between 0.05 and 0.3, measured according to the procedure detailed in the description).

Moreover the (DScat)_{extraction} of the cationic guar used in solution 5 is greater than the (DScat)_{extraction} of the cationic guar used in solution 4, which is greater than the (DScat)_{extraction} of the cationic guar used in solution 3 (i.e. (DScat)_{extraction} Jaguar C500®<(DScat)_{extraction} Jaguar C13S®<(DScat)_{extraction} Jaguar C17®).

The guars used in solutions 3, 4 and 5 also have an average molecular weight in accordance with the invention (and more especially an average molecular weight comprised between 100,000 and 3,000,000 g/mol, measured by SEC-MALS analyses according to the procedure detailed in the description).

### Soil Preparation

A mix of oils is prepared by mixing sunflower (60% by weight in respect of the total weight of the mix), colza (20% by weight in respect of the total weight of the mix) and olive (20% by weight in respect of the total weight of the mix) and heating 48 hours at 150° C.

Some carbon black is added to get a strong coloration. Care should be taken not to add too much carbon black, which could cause a “blooming” effect (blooming affect—after tile is rinsed, soil left over will release carbon black and cover most of the area on the tile making it hard to differentiate the test and control).

Approximately 3 mL of soil is applied on the surface with a pipette.

The soil is immediately wiped with cold tap water (flow around 8 L/min) during 20 sec. The surface is then dried at vertical position.

A second soiling cycle can be done without reapplying any treatment.

### Results: Anti-Soil Benefit of Cationic Guar in HSC Composition

The result of the effect of the composition according to the invention on soil deposition is evaluated after one cycle.
Good detergency: totally degreased surface (no soiled).
Medium detergency: partially degreased surface (partially soiled).
Bad detergency: presence of grease onto surface (soiled)

| | Reference solution | | | | |
|---|---|---|---|---|---|
| | Solution 1 | Solution 2 | Solution 3 | Solution 4 | Solution 5 |
| Soiled | No soiled | Partially | No soiled | No soiled | No soiled |
| | | soiled | | | |

The results show that with the reference solution and with the non cationic guar it remains soil, whereas with the commercial composition and especially with the composition of the invention there is no further soil. The cationic guar allows improving the cleaning of hard surfaces, specifically in anti-soil performances.

### EXAMPLE 2

### Hydrophilization Performances

Protocol:

The tile is cleaned with an alkaline detergent, and then rinsed with pure water and then ethanol, and finally the sample is dried

10 drops of detergent formulation are applied with a pipette for one part of the tile and the part is wiped with a kimwipe

Then water is sprayed at 3-4 cm from the surface and it is observed if there is the build-up of a continuous film of water.

It is possible to observe the hydrophilization performances.
if we have a thin, continuous, stable film of water, score is ++.
if there is formation of a continuous film of water, that retracts quickly, score is +.
if we have no difference between a new surface or a treated surface (lots of droplets) score is 0.
if we have an hydrophobation of the surface, score becomes −.

### Detergent Formulations Tested: Kitchen Cleaner

Reference Solution (No polymer): Mirataine JC HA 0.9%, Rhodoclean EFC 1%, Isopropanol 3%, Dowanol PnB, water. pH 8.5
Solution 1: Reference solution +1% MIRAPOL Surf-S210 (2.2% active), water pH 8.5
Solution 2:: Reference solution +1% of a solution at 2.2% guar (non cationic) Jaguar S, water pH 8.5
Solution 3: Reference solution +1% of a solution at 2.2% of a cationic guar sold by Rhodia under the trade name Jaguar C500®, water pH 8.5
Solution 4:: Reference solution +1% of a solution at 2.2% of a cationic guar sold by Rhodia under the trade name Jaguar C135®, water pH 8.5
Solution 5:: Reference solution +1% of a solution at 2.2% of a cationic guar sold by Rhodia under the trade name Jaguar C17®, water pH 8.5

As indicated previously, all the guars used in solutions 3, 4 and 5 have a (DScat)_{extraction} and an average molecular weight in accordance with the invention.

| | Reference | Solu- | Solu- | Solu- | Solu- | Solu- |
|---|---|---|---|---|---|---|
| | solution | tion 1 | tion 2 | tion 3 | tion 4 | tion 5 |
| Percentage | | | 0.022 | 0.022 | 0.022 | 0.022 |
| of guar | | | | | | |
| Melamine tile | − | − | + | + | ++ | ++ |

### Results:

The use of cationic guar in detergent composition for hard surface cleaning provides hydrophilization of hard surfaces and especially improved hydrophilization of hard surfaces in regards to commercial formulation. Higher the Degree of substitution (cationicity) is, better is the hydrophilization.

1. A hard surface cleaning composition comprising at least one cationic polysaccharide having an average molecular weight comprised between 20,000 and 5,000,000 g/mol.

2. Composition according to claim 1, wherein the cationic group of the cationic polysaccharide is non-polymer cationic group.

3. Composition according to claim 1, wherein the degree of cationisation of the polysaccharide is comprised between 0.05 and 0.5.

4. Composition according to claim 1, wherein the degree of cationisation of the polysaccharide is comprised between 0.05 and 0.3

5. Composition according to claim 1, wherein the cationic polysaccharide is cationic cellulose, cationic starch or cationic guar.

6. Composition according to claim 1, wherein the cationic polysaccharide is cationic guar.

7. Composition according to claim 6, wherein the cationic guar is a guar modified by a quaternary ammonium group.

8. Composition according to claim 6, wherein the cationic guar comprises a cationic group chosen from trialkylammonium groups, such as trimethyl ammonium, triethylammonium or tributylammonium groups); aryldialkylammonium groups, such as benzyldimethylammonium groups; and/or ammonium radicals in which the nitrogen atom is a member of a cyclic structure, such as pyridinium and imidazoline.

9. Composition according to claim 1 suitable to hydrophilize a hard surface and/or to provide anti-deposition, anti-adhesion and anti-soil properties to said surface.

10. Composition according to claim 1, wherein the weight ratio of the polysaccharide according to the total weight of the cleaning composition is comprised between 0.01% and 1% based on active.

11. Composition according to claim 1, further comprises one or more of the following compounds: surface-active agents, cationic polysaccharide, pH modifiers, water, cleaning or degreasing organic solvents, cosolvents, cationic biocides or disinfectants.

12. Use of at least one cationic polysaccharide as defined in claim 1 to hydrophilize a hard surface and/or to provide anti-deposition, anti-adhesion and anti-soil properties to said surface.

13. Use according to claim 12, wherein the polysaccharide is comprised in a hard surface cleaning composition.

14. A method for hydrophilizing a hard surface having a hydrophobic surface, comprising treating at least a portion of such hydrophobic surface with the cationic polysaccharide as such, such as defined in claim 1 to deposit a hydrophilizing layer on such portion of such hydrophobic surface.

15. The method according to claim 14 wherein the cationic polysaccharide is comprised in a hard surface cleaning composition.

16. A method for providing anti-deposition, anti-adhesion and anti-soil properties to a hard surface comprising treating at least a portion of such surface with the cationic polysaccharide as such, such as defined in claim 1.

17. The method according to claim 16 wherein the cationic polysaccharide is comprised in a hard surface cleaning composition.
